(19) United States
(12) Patent Application Publication
(10) Pub. No.: US 2004/0020288 A1
(43) Pub. Date: Feb. 5, 2004

(54) Liquid level detector

(75) Inventors: Katsuhide Tsukamoto, Tokyo (JP); Norifumi Yoshida, Tokyo (JP)

Correspondence Address: ARMSTRONG, KRATZ, QUINTOS, HANSON & BROOKS, LLP, 1725 K STREET, NW, SUITE 1000, WASHINGTON, DC, 20006, US

(73) Assignee: LINTEC CORPORATION, Tokyo (JP)

(21) Appl. No.: 10/618,700

(22) Filed: Jul. 15, 2003

(30) Foreign Application Priority Data
Jul. 31, 2002 (JP) 2002-222919

(51) Int. Cl. G01F 23/00

(52) U.S. Cl. 73/298

(57) ABSTRACT

A nozzle 21 is arranged in an ink pan 11 containing ink I, and air A is discharged from an opening 21A of the nozzle 21 into ink I. Back pressure P1 in the nozzle 21 is detected by a sensor 25, and by detecting changes in the back pressure P1, a liquid level is detected. The opening 21A of the nozzle 21 is opened in a direction inclined with respect to the axial direction of the nozzle 21, and by holding the nozzle 21 generally vertically, the opening 21A is set in a way of being inclined with respect to the liquid level L.

### BACKGROUND OF THE INVENTION

1. Field of the Invention

The present invention relates to a liquid level detector, more specifically, the invention relates to a liquid level detector that enables to detect the liquid level of a viscous liquid with high accuracy.

2. Description of the Related Art

Conventionally, printers such as flexographic presses and the like have a fountain roll arranged to be soaked in ink contained in an ink pan, and ink adhering to the external circumferential surface of the fountain roll is printed via an anilox roll and a plate cylinder onto print sheets. Therefore, as printing is proceeded, the amount of ink in the ink pan decreases with time, and when the level thereof goes below a specific level, it is necessary to replenish ink.

One known arrangement of a liquid level detector is to arrange a nozzle 51 in an ink pan 50 whereby the nozzle can discharge air into ink I and the liquid level is detected through detection of back pressure or return pressure. More specifically, a nozzle 51 is arranged in an ink pan 50 with the opening 51A soaked below the liquid level L, and air A supplied to the nozzle 51 is discharged from the opening 51A and passes through ink I toward the atmosphere above the liquid level L. Accordingly, when the opening 51A of the nozzle 51 is below the liquid level L, the air discharge condition becomes worse, and the back pressure P1 in the nozzle 51 becomes high, and this high status of the back pressure P1 may be taken as a sign that the liquid level is at a level not requiring replenishment of ink I. On the other hand, when the liquid level L goes below the opening 51A of the nozzle 51, air discharge condition becomes better immediately, the above mentioned back pressure P1 becomes low. Therefore, on the condition of decrease of the back pressure P1, it is possible to judge that the liquid level L has become below a specific level.

However, in printers such as flexographic presses, since a high viscosity ink I may be employed in many cases, there is a problem that the liquid level cannot be detected with high accuracy through monitoring the back pressure P1 in the nozzle 51. This is caused by the fact that air A discharged from the opening 51A of the nozzle 51 tends to form a large air bubble A1 as a lump under the opening 51A. And this air bubble A1 will gradually swell downward below the opening 51A due to no escape space above, as a consequence, the back pressure P1 is detected as if the air discharge condition comes better and despite that ink I is still above the level that requires no replenishment of ink I, a pump not illustrated herein will get started to supply ink I, consequently leading to ink flowing out of the ink pan 50, which is another problem with the prior art.

### SUMMARY OF THE INVENTION

The present invention has been made in taking notice of these problems in the prior art and the object of the present invention is to provide a liquid level detector wherein discharged air from an opening of a nozzle into liquid is released upwards stably thus an airflow condition is maintained steady, thereby the liquid level is detected with high accuracy.

To achieve the object, in a liquid level detector wherein a nozzle is arranged in a container containing liquid, air is discharged from an opening of the nozzle, and back pressure in the nozzle is detected, thereby the liquid level is detected, the present invention adopts such a way as the opening of the nozzle is arranged inclined with respect to liquid level. A structure arranged like this can make the direction of air flow constant towards the inclined direction of the opening, and generates air flows in the direction of cutting across the vertical direction, thereby avoiding a possibility to form a large air bubble under the opening, and can discharge air to the atmosphere above the liquid level. Consequently, it is possible to solve the problem in the prior art that liquid is supplied into a container in the status not requiring replenishment of liquid, namely, the status where the liquid level is above a specified level.

In the present invention the opening of the nozzle may be opened in a direction inclined with respect to the axial direction of the nozzle. Such structure enables to position the axis of the nozzle generally vertical hence it is easier to cope with a case of a small space for nozzle installation in a container.

Further, the opening of the nozzle may be opened in a direction generally perpendicular to the axial direction of the nozzle, and the nozzle is mounted with the axis thereof inclined with respect to the liquid level. Such structure enables to utilize existing nozzles, which can restrain the component parts costs.

### BRIEF DESCRIPTION OF THE DRAWINGS

FIG. 1 is a schematic side view embodying a liquid level detector in a printing unit of a flexographic press according to the present invention,

FIG. 2 shows a schematic diagram of the whole system of the liquid level detector,

FIG. 3 is a schematic side view showing a nozzle position when the liquid level is above a specific level,

FIG. 4 is a schematic side view showing a nozzle position when replenishment of liquid is required,

FIG. 5 is a schematic side view showing a modified example of a nozzle, and

FIG. 6 is a schematic side view showing actions of a nozzle in a conventional liquid level detector.

### DETAILED DESCRIPTION OF THE PREFERRED EMBODIMENT

An embodiment of the present invention applied to a printing unit of a flexographic press is described below in details with reference to the drawings.

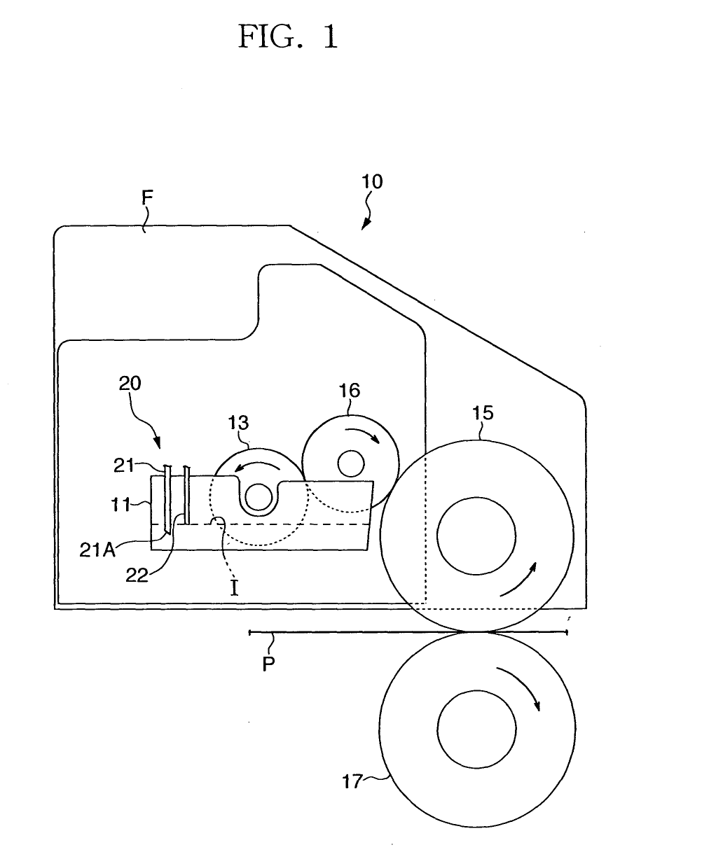

FIG. 1 shows a schematic side view of the printing unit. In this drawing, the printing unit 10 comprises an ink pan 11 as a container of ink(liquid) I installed in a frame F, a fountain roll 13 arranged in the ink pan 11 so that ink I would adhere to the external circumferential surface thereof, an anilox roll 16 for transferring ink I via the fountain roll 13 to a plate cylinder 15, and an impression cylinder platen 17 arranged so as to stand face to face with the plate cylinder 15, wherein a print sheet P is made to pass through between the impression cylinder platen 17 and the plate cylinder 15, thereby specific printing is carried out onto the print sheet P.

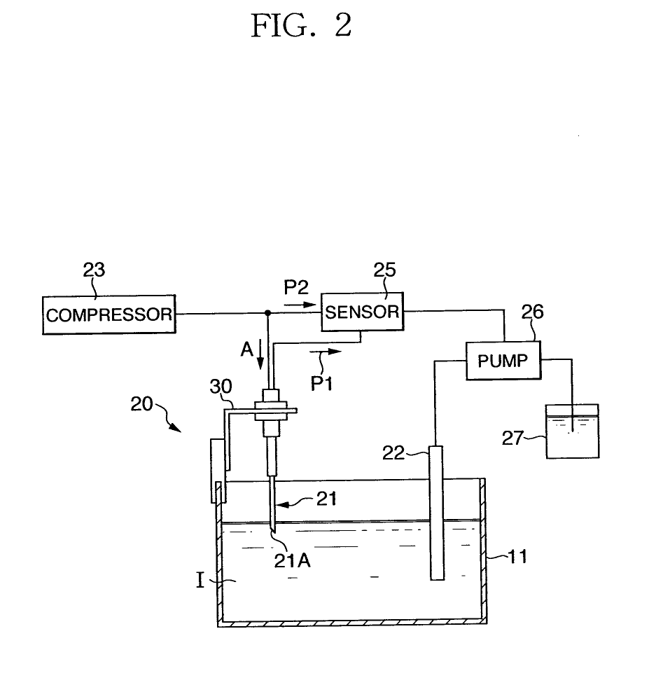

In the ink pan 11, a nozzle 21 comprising a liquid level detector 20 and an ink supply pipe 22 for supplying ink I into the ink pan 11 are mounted. The liquid level detector 20, as shown in FIG. 2, includes a sensor 25 for detecting supply pressure P2 supplied from a compressor 23 to the nozzle 21 and the back pressure P1 in the nozzle 21, and corresponding to the output of the sensor 25, a pump P is controlled ON/OFF. Accordingly, when the pump 26 works, ink I in a tank 27 is supplied via the ink supply pipe 22 into the ink pan 11.

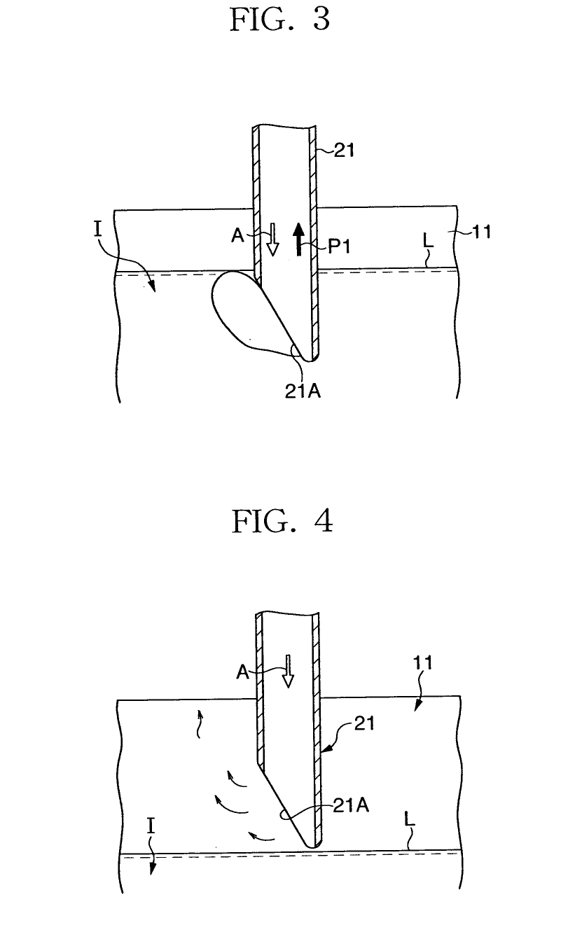

The nozzle 21 is attached via a supporting component 30 to the upper portion of the ink pan 11 as shown in FIG. 2 and FIG. 3, and is structured by a generally straight tube made of a pipe material. The nozzle 21 is arranged so that the end thereof, i.e., an opening 21A at the bottom end thereof is opened in a direction inclined with respect to the axial direction of the nozzle 21, thereby, air A discharged from the opening 21A into ink I constantly flows transversely across the axial direction.

The opposite end of the opening of the nozzle 21 is connected to the sensor 25, thereby the back pressure P1 in the nozzle 21 is detected by the sensor 25. While, air supplied from the compressor 23 is supplied also to the sensor 25, and the sensor 25 detects air supply pressure P2 from the compressor 23, and compares the supply pressure P2 with the back pressure P1, thereby monitors the discharge condition of air A discharged from the nozzle 21.

In the next place, a method to detect a liquid level in this embodiment is explained hereinafter.

As shown in FIG. 3, in the case when the opening 21A of the nozzle 21 is below the liquid level L, it is assumed that there is a necessary amount of ink I in the ink pan 11, and it is preset that there is no need to replenish ink I. In this status, when air A is supplied from the compressor 23, the supplied air is discharged from the opening 21A of the nozzle 21 into ink I, and at the same time, the supply pressure P2 is detected by the sensor 25. The air A discharged from the nozzle 21, under specific resistance due to the existence of ink I, causes specific back pressure P1 in the nozzle 21. The back pressure P1 is compared with the supply pressure P2 detected by the sensor 25, and the sensor 25 judges whether a preset pressure ratio is maintained or not. Since the opening 21A of the nozzle 21 is opened in the direction inclined with respect to the axial direction of the nozzle 21, the air A is discharged in the horizontal direction, and may bubble up on the liquid level L, but does not affect actions of the sensor 25 so long as the specific back pressure P1 occurs.

As printing goes on and the amount of ink I in the ink pan decreases, the position of the liquid level L goes down accordingly(Refer to FIG. 4). In this status, the flow resistance of the air discharged from the opening 21A of the nozzle 21 becomes small immediately, and the back pressure P1 will go down accordingly. At this moment, the sensor 25 detects the change in the pressure ratio of the back pressure P1 and the supply pressure P2, and outputs a supply signal of ink I to the pump P, thereby, ink I in the tank 27 is supplied through the ink supply pipe 22 into the ink pan 11. This ink supply is continued until the pressure ratio of the back pressure P1 and the supply pressure P2 becomes a preset value.

In the present embodiment the replenishment timing of ink I, namely, the ratio of the back pressure P1 and the supply pressure P2 of the air A, can be set with the reference ratio at the moment when the entire portion of the opening 21A appears above the liquid level L. The present invention, however, is not limited to this. For example, the replenishment timing may be set according to the ratio of the back pressure P1 and the supply pressure P2 at the moment when about a half portion of the opening 21A appears above the liquid level L.

Therefore, according to the preferred embodiment mentioned above, since the air A discharged from the nozzle 21 does not form a large air bubble in the ink pan 11, an improper operation of the pump 26 which may be caused in the case of viscous ink I especially, can be securely prevented.

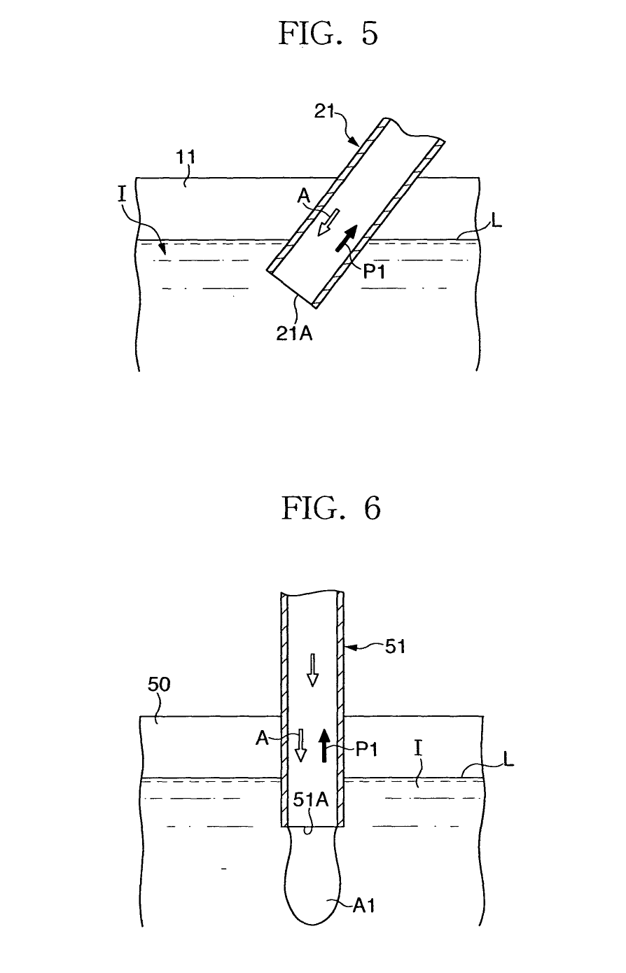

In the above preferred embodiment, the case that the opening 21A of the nozzle 21 is arranged in a direction inclined to the axial direction of the nozzle 21 is illustrated and explained, however, the present invention is not limited to this. For example, as shown in FIG. 5, even if the opening 21A is formed in the direction generally perpendicular to the axial direction of the nozzle 21, the nozzle 21 itself may be fixed in a inclined position so that the opening 21A is opened toward the liquid level L. Such structure may attain substantially same effects as the above mentioned embodiment.

Further, a small hole may be arranged in the halfway portion of the nozzle 21. For instance, in such case as the liquid level L at which ink supply is to be stopped or started is supposed to be a level at which the upper open portion of the opening 21A is positioned slightly above the liquid level, the condition of ink supply start and stop may be set based on the interrelationship between the cross sectional area of the upper open portion and the relevant back pressure. Accordingly, if there is a hole in the halfway portion of the nozzle 21, and the liquid level, for example, is at a level not requiring the supply of ink I, i.e., when the entire opening 21A is below the liquid level, air is discharged from the hole, and the back pressure P1 corresponding thereto is always detected. As a consequence, arranging a hole in the nozzle 21 may more securely avoid an improper operation of supplying ink I unnecessarily.

And, in the above preferred embodiment, a structure is employed wherein air A from the compressor 23 is supplied to the sensor 25 and thereby the supply pressure P2 is detected, while, this air supply to the sensor may be omitted. In this case, a reference pressure to determine ink supply timing may be set into the sensor 25, and the back pressure P1 in the nozzle 21 may be compared with the reference pressure, thereby the pump 26 may be turned ON/OFF. Such arrangement can simplify the circuit structure of a liquid level detector.

And, in the above preferred embodiment, the case has been explained wherein the present invention is applied to the ink pan in a printing unit of a flexographic press, while the present invention may be generally applied as a liquid level detector when the amount of a liquid will change with time.

As described heretofore, according to the present invention, since a liquid level detector is structured wherein the opening of a nozzle is arranged to be inclined with regard to the liquid level, it is possible to realize air discharging wherein air flow direction is always constant toward the inclined direction of the opening. Accordingly, it is possible to discharge air above the liquid level without forming a large air bubble under the opening of a nozzle as seen in the prior art wherein the air is discharged in the direction crossing the vertical direction and the opening is arranged generally in parallel with the liquid level. Consequently, it is possible to securely solve the prior problem of supplying liquid into a container in a status when the liquid level is still above a specific level, and also it is possible to prevent a liquid from flowing out of a container.

Further, according to the structure wherein the opening of a nozzle is opened in a direction inclined with respect to the axial direction of the nozzle, it is possible to arrange the axis of the nozzle generally vertically, thereby it is possible to easily cope with a small space for installing the nozzle in the container.

Furthermore, according to the structure wherein the opening of a nozzle is opened in a direction generally perpendicular to the axial direction of the nozzle, and the nozzle is arranged with the axis thereof inclined toward the liquid level, it is possible to reduce parts costs since existing nozzles may be employed.

What is claimed is:

1. A liquid level detector wherein a nozzle is arranged in a container containing liquid, and air is discharged into the liquid from an opening of said nozzle and the back pressure in said nozzle is detected, thereby the liquid level is detected, and
said liquid level detector being characterized by said opening of said nozzle is arranged to be inclined with respect to the liquid level.

2. A liquid level detector according to claim 1, wherein said opening of said nozzle is opened in a direction inclined with respect to the axial direction of said nozzle.

3. A liquid level detector according to claim 1, wherein said opening of said nozzle is opened in a direction generally perpendicular to the axial direction of said nozzle, and said nozzle is arranged with the axis thereof inclined with respect to said liquid level.
